(19) United States
(12) Patent Application Publication
(10) Pub. No.: US 2006/0053917 A1
(43) Pub. Date: Mar. 16, 2006

(54) Plastic gear

(76) Inventors: Tsuneo Asari, Nagano-pref (JP); Fumio Emori, Nagano-pref (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/212,417

(22) Filed: Aug. 26, 2005

(30) Foreign Application Priority Data
Aug. 31, 2004 (JP) 2004-251423

(51) Int. Cl. F16H 1/14

(52) U.S. Cl. 74/423

(57) ABSTRACT

A plastic gear includes a teeth part formed on its outer periphery, a web formed on the inner side of the teeth part and a plurality of ring-shaped rims concentrically formed such that the web is divided into a plurality of ring-shaped webs in a concentrically circular shape. The plurality of ring-shaped webs includes two or more ring-shaped webs without rib which has no ribs connecting adjacent ring-shaped rims on an outer peripheral side other than the ring-shaped web to which gates for resin molding are to be disposed at the time of resin molding.

### CROSS-REFERENCE TO RELATED APPLICATIONS

This application claims priority to Japanese Application No. 2004-251423 filed Aug. 31, 2004, which is incorporated herein by reference.

### BACKGROUND OF THE INVENTION

a) Field of the Invention

The present invention relates to a plastic gear which is used in office automation equipment such as a printer or a copying machine or in a precise driving system such as a window regulator for a car.

b) Description of the Related Art

A molded plastic gear used in office automation equipment such as a printer or a copying machine or in a precise driving system such as a window regulator for a car is molded by injecting molten resin into a cavity of molding dies for injection molding from gates (see, for example, Japanese Patent Laid-Open No. Hei 10-278124).

In such a plastic gear, a thin web 105 is formed on the inner side of a ring-shaped rim 130 near the bottom portion of a teeth part 103 formed on its outer periphery as shown in FIGS. 4(a) and 4(b). Two ring-shaped rims 141, 142 are formed on the web 105 and the ring-shaped rims 141, 142 divide the web 105 into three ring-shaped webs 151, 152, 153 in a concentrically circular shape. A plurality of ribs 161, 162 are respectively formed on the first ring-shaped web 151 and the second ring-shaped web 152 from the inside so as to extend in a radial direction. Therefore, the first ring-shaped web 151 and the second ring-shaped web 152 from the inside is formed in a ring-shaped web with rib but the third ring-shaped web 153 from the inside is formed in a ring-shaped web without rib. Further, a plurality of gates 109 will be disposed to the second ring-shaped web 152 from the inside at equal angular intervals at the time of resin molding.

In the plastic gear 101 having the structure described above, since the ring-shaped rims 141, 142 and the ribs 161, 162 are formed on the web 105, reduction of weight and improvement of rigidity can be attained. Further, since the ring-shaped web 153 on the most outer peripheral portion is formed in a shape without rib, molding sink does not occur on the teeth part 103 at the time of resin molding because the ribs are not formed.

However, in the plastic gear 101 shown in FIGS. 4(a) and 4(b), since the gates 109 for resin molding are located on the outer peripheral side and near the teeth part 103, a large difference of injection pressures between the far portion and the near portion of the gate 109 in the circumferential direction occurs in the teeth part 103. In other words, the injection pressure is the highest in the nearest portion to the gate 109 and the injection pressure gradually decreases according to the separation from the nearest portion in the circumferential direction. Therefore, variation occurs in transferability to the teeth part 103 and thus a high degree of meshing accuracy is not attained.

In order to eliminate the above-mentioned problems, it is conceivable that the gates 109 are disposed on the ring-shaped web 151 on the inner peripheral side at equal angular intervals as shown in FIGS. 5(a) and 5(b) (not prior art). However, when the gates 109 are disposed on the ring-shaped web 151 on the inner peripheral side, the teeth part 103 is located at a position apart from the gates 109. Therefore, a high pressure is required to be applied to the molding resin (as much as possible) to enhance its transferability and, as a result, effects of the ribs 161, 162 cannot be restrained by only providing the ring-shaped web 153 on the outermost peripheral portion. Consequently, it is very difficult for a molded plastic gear to be formed with a high degree of accuracy such as the first grade or the zero grade of the Japanese gear industrial standard (JGMA standard).

### SUMMARY OF THE INVENTION

In view of the problems described above, it is a primary object and advantage of the present invention to provide a plastic gear in which a teeth part can be formed on its outer periphery with a high degree of accuracy even when produced by injection molding.

In order to achieve the above object and advantage, according to an embodiment of the present invention, there is provided a plastic gear including a teeth part which formed on its outer periphery, a web which is formed on the inner side of the teeth part, and a plurality of ring-shaped rims which is concentrically formed such that the web is divided into a plurality of ring-shaped webs in a concentrically circular shape. The plurality of ring-shaped webs includes two or more ring-shaped webs without rib which has no ribs for connecting adjacent ring-shaped rims on an outer peripheral side other than the ring-shaped web to which gates for resin molding are disposed at the time of resin molding.

In accordance with an embodiment of the present invention, gates for resin molding are disposed on an inner peripheral side and kept away from the teeth part when a plastic gear is resin molded. Therefore, a large difference of injection pressures is not generated between a portion near the gate and a portion far away from the gate in the teeth part. Accordingly, variation does not occur in the transferability to the teeth part. Further, when the gates are disposed on the inner peripheral side, the transferability in the teeth part is required to be enhanced by increasing the injection pressure. Even in this case, according to an embodiment of the present invention, two or more ring-shaped webs without rib are disposed on an outer peripheral side of the ring-shaped web to which the gates are disposed. Therefore, even when the ribs are formed on other ring-shaped webs, the ribs do not affect the shape and the dimensional accuracy of the teeth part. Alternatively, also in the case that all the ring-shaped webs are formed in a ring-shaped web without rib, the ribs do not affect the shape and the dimensional accuracy of the teeth part. As a result, for example, even when a large diameter of plastic gear with the diameter of 40 mm or more is produced, the accuracy of the first grade and the zero grade of the JGMA standard can be attained.

In accordance with an embodiment of the present invention, it is preferable that two or more ring-shaped webs without rib include an outermost peripheral ring-shaped web. According to the construction described above, molding sink due to the presence of the ribs does not occur on the teeth part at the time of resin molding.

In accordance with an embodiment of the present invention, the plurality of ring-shaped webs may include two or more ring-shaped webs without rib and at least a ring-shaped web with rib on which ribs are formed in the radial direction. In this case, it is preferable that the ring-shaped webs without rib and the ring-shaped web with rib are alternately disposed. According to the construction described above, the disturbance of the flow of the molten resin in the ring-shaped web with rib can be effectively reduced by the ring-shaped web without rib adjacent on the outer peripheral side. Further, when two or more ring-shaped webs with rib are disposed, it is preferable that the respective angular positions of ribs that are formed on one of the ring-shaped web with rib deviate from those of ribs that are formed on another of the ring-shaped web with rib. According to the construction described above, the shrinkage of resin in the ribs is not concentrated on specified positions in the circumferential direction and thus the shape and the dimensional accuracy of the teeth part are not deteriorated by the effects of the ribs.

In accordance with an embodiment of the present invention, all the plurality of ring-shaped webs may be ring-shaped webs without rib.

In accordance with an embodiment of the present invention, the gates for resin molding are preferably disposed to an innermost peripheral ring-shaped web.

In accordance with an embodiment of the present invention, the plurality of ring-shaped webs may include two or more ring-shaped webs without rib and at least a ring-shaped web with rib on which a plurality of ribs are formed in the radial direction. In this case, it is preferable that the gates for resin molding are disposed to the innermost peripheral ring-shaped web and at least the second ring-shaped web from the innermost peripheral ring-shaped web is the ring-shaped web without rib and the thickness of the second ring-shaped web is thinner by 0.5 mm or more than the thickness of the ring-shaped web with rib. According to the construction described above, after the flow of the molten resin which is injected from the gates is narrowed down by the second ring-shaped web, the molten resin flows down toward the outer peripheral side and thus injection pressure is uniformly applied there. Consequently, since the injection pressure is uniformly applied to the teeth part, plastic gear with a high degree of accuracy can be produced.

In accordance with an embodiment of the present invention, the plurality of ring-shaped webs may include two or more ring-shaped webs without rib and at least a ring-shaped web with rib on which a plurality of ribs are formed in the radial direction. In this case, it is preferable that the gates for resin molding are disposed to the innermost peripheral ring-shaped web and at least the second ring-shaped web from the innermost peripheral ring-shaped web is the ring-shaped web without rib and the ratio of the thickness of the second ring-shaped web without rib and the thickness of the ring-shaped web with rib is set to be within a range from (1:1.15) to (1:2). According to the construction described above, after the flow of the molten resin which is injected from the gates is narrowed down by the second ring-shaped web, the molten resin flows down toward the outer peripheral side and thus the injection pressure is uniformly applied there. Consequently, since the injection pressure is uniformly applied to the teeth part, plastic gear with a high degree of accuracy can be produced.

In accordance with an embodiment of the present invention, the width in a radial direction of the outermost peripheral ring-shaped web is preferably smaller than the widths in the radial direction of other ring-shaped webs. According to the construction described above, the rigidity of the outer peripheral side of the plastic gear can be increased and thus the insufficiency in the rigidity due to no rib being formed to the outermost peripheral ring-shaped web can be prevented and thus the deformation of the teeth part can be prevented when the gear meshes with another gear. Further, the disturbance of the flow of the molten resin is reduced by the ring-shaped web without rib that is formed on the inner side and thus the shape accuracy of the teeth part is not lowered even when the radial width of the outermost peripheral ring-shaped web is small.

As described above, in accordance with an embodiment of the present invention, two or more annular portions which respectively connect between adjacent ring-shaped rims through only a web without ribs on the flow path of the molten resin reaching to the teeth part from the gates. Therefore, when a molded plastic gear is formed by injection molding, the molten resin which is injected from the gates flows toward an outer peripheral side of the plastic gear, i.e., toward the teeth part through two or more above-mentioned annular portions. When the molten resin flowing along the ribs reaches the annular portion, the molten resin flows uniformly because the molten resin flows along the web without ribs. In other words, the annular portions serve respectively as a buffer for flowing molten resin. In accordance with an embodiment of the present invention, two or more above-mentioned annular portions are provided on the flow path of the molten resin from the gates to the teeth part and thus molten resin uniformly flows to a ring-shaped gear portion. Consequently, even a large diameter of plastic gear with the diameter of 40 mm or more can be produced with a high degree of accuracy and its gear accuracy can be remarkably improved in comparison with a conventional molded plastic gear.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1(a) is a front view showing a molded plastic gear in accordance with a first embodiment of the present invention and FIG. 1(b) is a schematic cross-sectional view showing the portion which is cut by the line of A-A′ in FIG. 1(a);

FIG. 2(a) is a front view showing a plastic gear in accordance with a second embodiment of the present invention and FIG. 2(b) is a schematic cross-sectional view showing the portion which is cut by the line of B-B′ in FIG. 2(a);

FIG. 3(a) is a front view showing a molded plastic gear in accordance with a third embodiment of the present invention and FIG. 3(b) is a schematic cross-sectional view showing the portion which is cut by the line C-C′ in FIG. 3(a);

FIG. 4(a) is a front view showing a conventional molded plastic gear and FIG. 4(b) is a schematic cross-sectional view showing the portion which is cut by the line D-D′ in FIG. 4(a); and

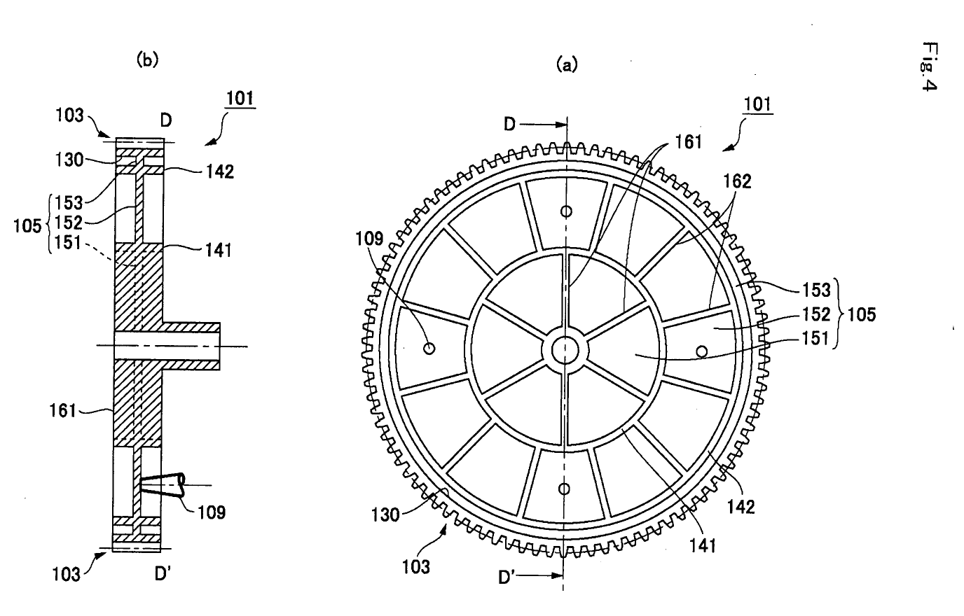

FIG. 5(a) is a front view showing a molded plastic gear as a comparison example (not prior art) and FIG. 5(b) is a schematic cross-sectional view showing the portion which is cut by the line E-E′ in FIG. 5(a).

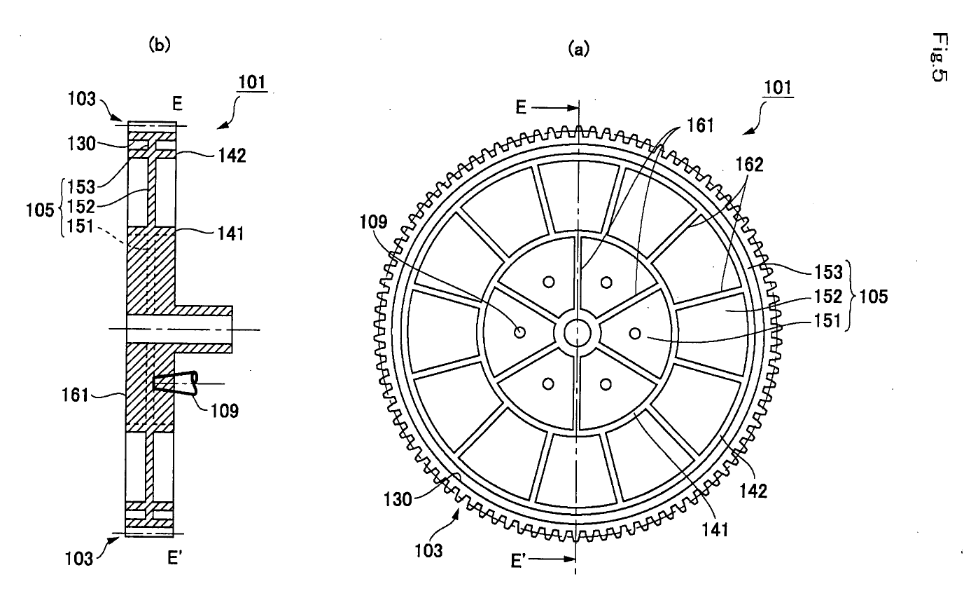

### DESCRIPTION OF THE PREFERRED EMBODIMENTS

### First Embodiment

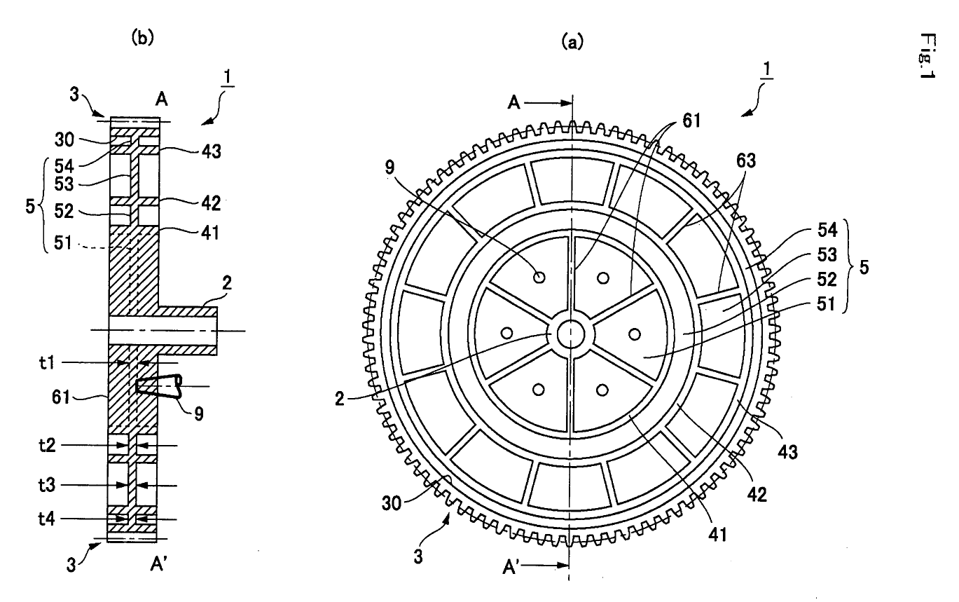

A plastic gear in accordance with a first embodiment of the present invention will be described below with reference to the accompanying drawings. FIG. 1(a) is a front view showing a molded plastic gear in accordance with the first embodiment of the present invention and FIG. 1(b) is a schematic cross-sectional view showing the portion that is cut by the line of A-A′ in FIG. 1(a).

As shown in FIGS. 1(a) and 1(b), a plastic gear 1 in the first embodiment of the present invention is used in office automation equipment such as a printer or a copying machine or in a precise driving system such as a window regulator for a car. The diameter of the plastic gear 1 is set to be large such as about 40 mm or more.

In the first embodiment of the present invention, the plastic gear 1 is provided with a cylindrical hub 2 at its center portion and a teeth part 3 on its outer peripheral portion. In the plastic gear 1, the inner side portion of a ring-shaped rim 30 near the tooth bottom portion is hollowed and a thin thickness web 5 is formed between the hub 2 and the teeth part 3. A plurality of thick ring-shaped rims 41, 42, 43 which divide the web 5 into a plurality of ring-shaped webs 51, 52, 53, 54 formed in a concentrically circular shape are formed on the web 5 in a concentrical shape. In the first embodiment of the present invention, four ring-shaped webs 51, 52, 53, 54 are formed by three ring-shaped rims 41, 42, 43.

A plurality of pinpoint gates 9 for resin molding the plastic gear 1 are to be disposed at equal angular intervals to the ring-shaped web 51 at the innermost peripheral portion. A plurality of ribs 61 is disposed on both sides of the ring-shaped web 51 at the innermost peripheral portion in the radial direction and thus the ring-shaped web 51 is formed as a ring-shaped web with rib. The hub 2 and the ring-shaped rim 41 are connected to each other by the ribs 61. In this embodiment of the present invention, the pinpoint gates 9 are respectively disposed at each of six portions between the ribs 61.

The second ring-shaped web 52 from the innermost side is formed as the ring-shaped web without rib which is provided with no rib on its both sides.

The third ring-shaped web 53 from the innermost side is formed as the ring-shaped web with rib which is provided with a plurality of ribs 63 disposed in the radial direction on its both sides. The rim 42 and the rim 43 are connected to each other by the ribs 63. In this embodiment of the present invention, twelve ribs 63 are formed. These ribs 63 are formed at different angular positions which completely deviate from those of the ribs 61 which are formed on the ring-shaped web 51 at the innermost peripheral portion.

The fourth ring-shaped web 54 (the outermost peripheral ring-shaped web) is formed as the ring-shaped web without rib which is provided with no rib on its both sides.

When the thickness of the second ring-shaped web 52 from the innermost side which is the ring-shaped web without rib is set to be “t2” and the thicknesses of the first and the third ring-shaped webs 51, 53 from the innermost side which are the ring-shaped webs with rib are set to be respectively “t1” and “t3”, the relationships of the thicknesses “t1”, “t2”, “t3” are set to be the following expressions:
t2<t1=t3
t2:t1=1:1.15˜1:2

Alternatively, when the thickness of the second ring-shaped web 52 from the innermost side which is the ring-shaped web without rib is set to be “t2” and the thicknesses of the first and the third ring-shaped webs 51, 53 from the innermost side which are the ring-shaped webs with rib are set to be respectively “t1” and “t3”, the relationships of the thicknesses “t1”, “t2”, “t3” may be designed to satisfy the following expressions:
t2<t1=t3
t1−t2=0.5 mm
For example, when the thickness “t2” of the second ring-shaped web 52 is set to be 2.0 mm, the thicknesses “t1”, “t3” of the first and the third ring-shaped webs 51, 53 are set to be 2.5 mm.

The thickness “t4” of the fourth ring-shaped web 54 (the outermost peripheral ring-shaped web) which is the ring-shaped web without rib is designed similar to the case of the thickness “t2” of the second ring-shaped web 52 which is also the ring-shaped web without rib.

The plastic gear 1 is molded by using molten resin such as POM (polyoxymethylene) which is injected from pinpoint gates 9 into a cavity of molding dies (not shown). In this case, the pinpoint gates 9 are disposed at positions corresponding to the innermost ring-shaped web 51. Therefore, the molten resin moves toward the teeth part 3 from the pinpoint gates 9 through the respective ring-shaped webs 51, 52, 53, 54, the ribs 61, 63, and the ring-shaped rims 41, 42, 43, 30. In this case, the ring-shaped rims 41, 42, 43, 30 serve as buffer functions for flowing molten resin and the molten resin flows uniformly from the ring-shaped rims 41, 42, 43, 30 toward the teeth part 3.

As described above, in the first embodiment of the present invention, when the plastic gear 1 is resin molded, the pinpoint gates 9 are disposed at the positions corresponding to the innermost rig-shaped web 51 and are kept away from the teeth part 3. Therefore, a large difference of the injection pressures between the near and far portions from the pinpoint gates 9 in the circumferential direction is not generated in the teeth part 3 and thus the variation of transferability does not occur in the teeth part 3. When the pinpoint gates 9 are disposed on the inner peripheral side, a high degree of transferability in the teeth part 3 requires increasing the injection pressure. According to the first embodiment of the present invention, the second ring-shaped web 52 from the innermost side is also formed as the ring-shaped web without rib like the outermost peripheral ring-shaped web 54. Therefore, even when the thick ribs 61, 63 are formed on the ring-shaped webs 51, 53, the shrinkage of resin which is apt to occur at the portions corresponding to the ribs 61, 63 does not affect the shape and the dimensional accuracy of the teeth part 3. As a result, in accordance with the first embodiment of the present invention, even a large diameter of plastic gear 1, for example, with the diameter of 40 mm or more, can be produced with a high degree of accuracy. According to the meshing tests based on the JGMA standard that the present inventors have performed, the gear accuracy has been improved by 20 μm to 40 μm in comparison with the conventional gears and the accuracy of the first grade and the zero grade of the JGMA standard has been attained. Further, the tests of the tooth profile and the tooth trace based on the Japanese Industrial Standard (JIS) have revealed the measured values that are approximately equal to the calculated values.

Further, in this embodiment of the present invention, the ring-shaped webs 52, 54 without rib and the ring-shaped webs 51, 53 with rib are alternately disposed. Therefore, the disturbance of the flow of the molten resin in the ring-shaped webs 51, 53 with rib can be effectively reduced by the ring-shaped webs 52, 54 without rib adjacent to the ring-shaped webs 51, 53 on the outer peripheral side.

In addition, in the ring-shaped webs 51, 53 with rib, the angular positions of the ribs 61, 63 are respectively deviated from each other and thus the shrinkage of resin in the ribs 61, 63 is not concentrated on specified positions in the circumferential direction. As a result, the shape and the dimensional accuracy of the teeth part 3 are not deteriorated by the effects of the ribs 61, 63.

Further, in this embodiment of the present invention, the second ring-shaped web 52 is the ring-shaped web without rib and the thickness of the second ring-shaped web 52 is thinner than that of the ring-shaped webs 51, 53 with rib. For example, the thickness of the second ring-shaped web 52 from the innermost side is thinner by 0.5 mm than that of the ring-shaped webs 51, 53 with rib. Further, the ratio of the thickness of the second ring-shaped web 52 from the innermost side and the thickness of the ring-shaped webs 51, 53 with rib is within the range from (1:1.15) to (1:2). Therefore, after the flow of the molten resin which is injected from the pinpoint gates 9 is narrowed down by the second ring-shaped web 52, the molten resin flows down toward the outer peripheral side and thus the injection pressure is uniformly applied to there. Consequently, since the injection pressure is uniformly applied to the teeth part 3, the plastic gear 1 with a high degree of accuracy can be produced.

In addition, since the radial width of the outermost peripheral ring-shaped web 54 is smaller than other ring-shaped webs 51, 52, 53, the rigidity of the outer peripheral side of the plastic gear 1 can be increased. Therefore, the insufficiency in rigidity due to having no rib formed to the outermost peripheral ring-shaped web 54 is prevented and thus deformation of the teeth part 3 can be prevented when the gear meshes with another gear. Further, the disturbance of the flow of the molten resin is restricted by the ring-shaped web 52 without rib which is formed on its inner side (the second ring-shaped web 52 from the innermost side), and thus the shape accuracy of the teeth part 3 is not lowered even when the radial width of the outermost peripheral ring-shaped web 54 is small.

### Second Embodiment

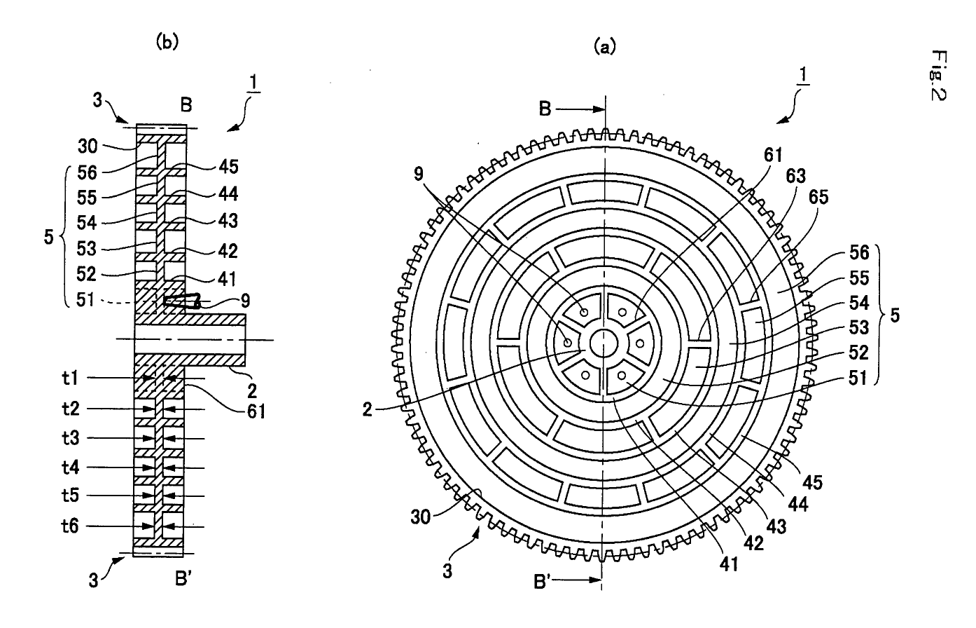

FIG. 2(a) is a front view showing a plastic gear in accordance with a second embodiment of the present invention and FIG. 2(b) is a schematic cross-sectional view showing the portion which is cut by the line of B-B′ in FIG. 2(a). The basic structures in the second embodiment and the third embodiment described later are similar to that in the first embodiment of the present invention. Therefore, the same notational symbols are used to the same portions providing the corresponding function and their descriptions are omitted.

As shown in FIGS. 2(a) and 2(b), similar to the first embodiment of the present invention, the plastic gear 1 in the second embodiment of the present invention is constructed such that the inside portion of the ring-shaped rim 30 near the tooth bottom portion is hollowed and a thin thickness web 5 is formed between the hub 2 and the teeth part 3. Five thick ring-shaped rims 41, 42, 43, 44, 45 which divide the web 5 into six ring-shaped webs 51, 52, 53, 54, 55, 56 formed in a concentrically circular shape are formed on the web 5 in a concentrical shape.

A plurality of pinpoint gates 9 for resin molding the plastic gear 1 are disposed at equal angular intervals to the ring-shaped web 51 at the innermost circumferential portion. Six ribs 61 are disposed on both sides of the ring-shaped web 51 at the innermost circumferential portion in the radial direction and thus the ring-shaped web 51 is formed as a ring-shaped web with rib. The hub 2 and the ring-shaped rim 41 are connected to each other by the ribs 61.

The second ring-shaped web 52 from the innermost side is formed as the ring-shaped web without rib which is provided with no rib on its both sides.

The third ring-shaped web 53 from the innermost side is formed as the ring-shaped web with rib which is provided with six ribs 63 disposed in the radial direction on its both sides. The rim 42 and the rim 43 are connected to each other by the ribs 63.

The fourth ring-shaped web 54 is formed as the ring-shaped web without rib which is provided with no rib on its both sides.

The fifth ring-shaped web 55 from the innermost side is formed as the ring-shaped web with rib which is provided with twelve ribs 65 disposed in the radial direction on its both sides. The rim 44 and the rim 45 are connected to each other by the ribs 63.

The sixth ring-shaped web 56 (the outermost peripheral ring-shaped web) is formed as the ring-shaped web without rib which is provided with no rib on its both sides.

When the thickness of the second ring-shaped web 52 from the innermost side which is the ring-shaped web without rib is set to be “t2” and the thicknesses of the first, the third and the fifth ring-shaped webs 51, 53, 55 from the innermost side which are the ring-shaped webs with rib are set to be respectively “t1”, “t3” and “t5”, the relationships of the thicknesses “t1”, “t2”, “t3”, “t5” are set to be the following expressions:
t2<t1=t3=t5
t2:t1=1:1.15˜1:2

Alternatively, when the thickness of the second ring-shaped web 52 from the innermost side which is the ring-shaped web without rib is set to be “t2” and the thicknesses of the ring-shaped webs 51, 53, 55 which are the ring-shaped webs with rib are set to be respectively “t1”, “t3”, “t5”, the relationships of the thicknesses “t1”, “t2”, “t3”, “t5” may be designed to satisfy the following expressions:
t2<t1=t3=t5
t1−t2=0.5 mm
For example, when the thickness “t2” of the second ring-shaped web 52 is set to be 2.0 mm, the thicknesses “t1”, “t3”, “t5” of the first, the third and the fifth ring-shaped webs 51, 53, 55 are set to be 2.5 mm.

The thickness “t6” of the sixth ring-shaped web 56 (the outermost peripheral ring-shaped web) which is the ring-shaped web without rib is designed similar to the case of the thickness “t2” of the second ring-shaped web 52 from the innermost side which is the ring-shaped web without rib.

Also in the structure according to the second embodiment of the present invention, the pinpoint gates 9 are disposed at positions corresponding to the innermost peripheral ring-shaped web 51 and kept away from the teeth part 3 when the plastic gear 1 is resin molded. Therefore, a large difference of the injection pressures between the near and the far portions from the pinpoint gates 9 in the circumferential direction is not generated in the teeth part 3 and thus the variation of transferability does not occur in the teeth part 3. Further, in the second embodiment of the present invention, the second and the fourth ring-shaped webs 52, 54 from the innermost side are formed as the ring-shaped web without rib as well as the outermost peripheral ring-shaped web 56. Therefore, in the case where the transferability in the teeth part 3 is enhanced by increasing the injection pressure, even when other ring-shaped webs 51, 53, 55 are formed with thick ribs 61, 63, 65, shrinkage of resin which is apt to be generated at portions corresponding to the ribs 61, 63, 65 does not exert effects on the shape and the dimensional accuracy of the teeth part 3. Consequently, according to this embodiment of the present invention, similar effects to that of the first embodiment of the present invention can be attained, for example, even when the plastic gear 1 whose diameter is 40 mm or more is produced, the accuracy of the first grade or the zero grade of JGMA standard can be ensured.

### Third Embodiment

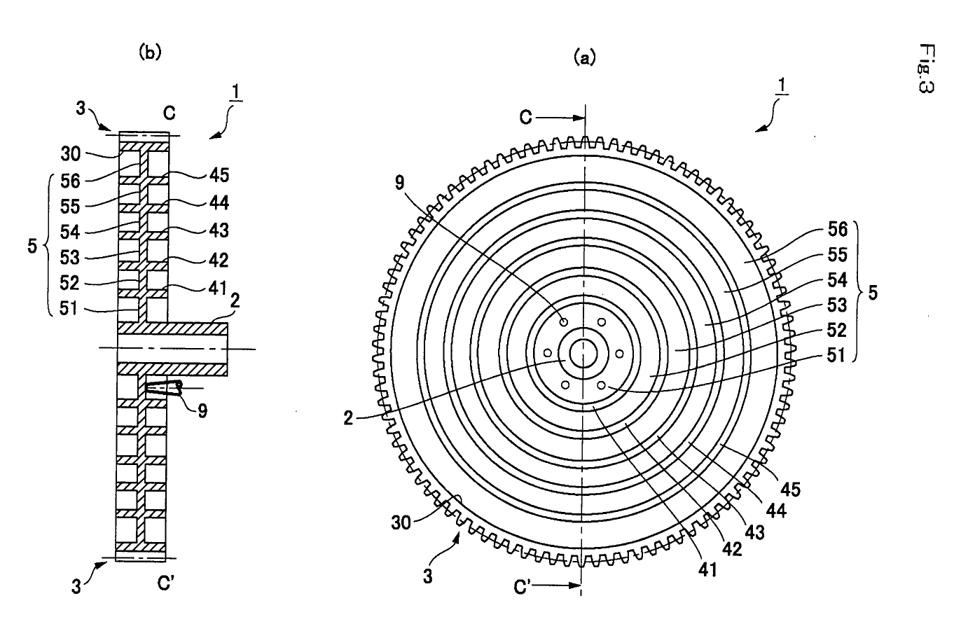

FIG. 3(a) is a front view showing a molded plastic gear in accordance with a third embodiment of the present invention and FIG. 3(b) is a schematic cross-sectional view showing the portion which is cut by the line C-C′ in FIG. 3(a).

As shown in FIGS. 3(a) and 3(b), similar to the first and the second embodiments of the present invention, the plastic gear 1 in the third embodiment of the present invention is constructed such that the inside portion of the ring-shaped rim 30 near the tooth bottom portion is hollowed and a thin thickness web 5 is formed between the hub 2 and the teeth part 3. Five thick ring-shaped rims 41, 42, 43, 44, 45 which divide the web 5 into six ring-shaped webs 51, 52, 53, 54, 55, 56 formed in a concentrically circular shape are formed on the web 5 in a concentrical shape. All of six ring-shaped webs 51, 52, 53, 54, 55, 56 are formed as the ring-shaped web without rib which is provided with no rib on its both sides.

Also in the structure according to the third embodiment of the present invention, the pinpoint gates 9 are disposed at positions corresponding to the innermost peripheral ring-shaped web 51 and kept away from the teeth part 3 when the plastic gear 1 is resin molded. Therefore, a large difference of the injection pressures between the near and the far portions from the pinpoint gates 9 in the circumferential direction is not generated in the teeth part 3 and thus variation of transferability does not occur in the teeth part 3. Further, in the third embodiment of the present invention, all of six ring-shaped webs 51, 52, 53, 54, 55, 56 are formed as the ring-shaped web without rib. Therefore, in the case where the transferability in the teeth part 3 is enhanced by increasing the injection pressure, the shrinkage of resin which is apt to be generated when ribs are formed does not exert effects on the shape and the dimensional accuracy of the teeth part 3.

### Other Embodiments

In all of the above-mentioned embodiments of the present invention, the ring-shaped rims and/or the ribs are formed on both faces of the web 5. However, the ring-shaped rims and/or the ribs may be formed on only one side face.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A plastic gear comprising:
a teeth part which formed on its outer periphery;
a web which is formed on an inner side of the teeth part; and
a plurality of ring-shaped rims which is concentrically formed such that the web is divided into a plurality of ring-shaped webs in a concentrically circular shape;
wherein the plurality of ring-shaped webs includes two or more ring-shaped webs without rib which has no ribs connecting adjacent ring-shaped rims on an outer peripheral side other than the ring-shaped web to which gates for resin molding are to be disposed at the time of resin molding.

2. The plastic gear according to claim 1, wherein the ring-shaped webs without rib include an outermost peripheral ring-shaped web.

3. The plastic gear according to claim 2, wherein a width in a radial direction of the outermost peripheral ring-shaped web is smaller than widths in the radial direction of other ring-shaped webs.

4. The plastic gear according to claim 3, wherein the plurality of ring-shaped webs includes two or more ring-shaped webs without rib and at least a ring-shaped web with rib.

5. The plastic gear according to claim 4, wherein a thickness of the ring-shaped web without rib is thinner by 0.5 mm or more than a thickness of the ring-shaped web with rib.

6. The plastic gear according to claim 1, wherein the plurality of ring-shaped webs includes two or more ring-shaped webs without rib and at least a ring-shaped web with rib on which a plurality of ribs are formed in the radial direction and an outermost peripheral ring-shaped web is the ring-shaped web without rib.

7. The plastic gear according to claim 6, wherein the ring-shaped webs without rib and the ring-shaped web with rib are alternately disposed.

8. The plastic gear according to claim 6, wherein at least a ring-shaped web with rib includes two or more ring-shaped webs with rib and respective angular positions of ribs which are formed on one of the ring-shaped web with rib deviate from respective angular positions of ribs which are formed on another of the ring-shaped web with rib.

9. The plastic gear according to claim 6, wherein
the gates for resin molding are to be disposed to an innermost peripheral ring-shaped web;
at least the second ring-shaped web from the innermost peripheral ring-shaped web is the ring-shaped web without rib; and
a thickness of the second ring-shaped web without rib is thinner by 0.5 mm or more than a thickness of the ring-shaped web with rib.

10. The plastic gear according to claim 6, wherein
the gates for resin molding are to be disposed to an innermost peripheral ring-shaped web;
at least the second ring-shaped web from the innermost peripheral ring-shaped web is the ring-shaped web without rib; and
a ratio of a thickness of the second ring-shaped web without rib and a thickness of the ring-shaped web with rib is set to be within a range from (1:1.15) to (1:2).

11. The plastic gear according to claim 6, wherein a width in a radial direction of the outermost peripheral ring-shaped web is smaller than widths in the radial direction of other ring-shaped webs.

12. The plastic gear according to claim 1, wherein all the plurality of ring-shaped webs are ring-shaped webs without rib.

13. The plastic gear according to claim 1, wherein the gates for resin molding are to be disposed to an innermost peripheral ring-shaped web.
